(19) United States
(12) Patent Application Publication
(10) Pub. No.: US 2025/0110506 A1
(43) Pub. Date: Apr. 3, 2025

(54) OPTIMIZATION OF PLANNED MOVEMENT OF INDUSTRIAL DEVICES

(71) Applicant: Telefonaktiebolaget LM Ericsson (publ), Stockholm (SE)

(72) Inventors: Norbert REIDER, Tényö (HU); Sándor RÁCZ, Cegléd (HU)

(21) Appl. No.: 18/833,107

(22) PCT Filed: Jan. 27, 2022
(86) PCT No.: PCT/SE2022/050079

§ 371 Date: Jul. 25, 2024

(51) Int. Cl. G05D 1/644; G05D 111/30; H04W 72/543

(52) U.S. Cl. CPC G05D 1/644; H04W 72/543; G05D 2111/32

(57) ABSTRACT

Embodiments of the present disclosure provide a method for optimizing a planned movement of one or more industrial devices in an industrial environment. The method is performed by a network node in the wireless communication network. The method includes acquiring at least one movement path for the one or more industrial devices, each movement path including one or more segments indicative of movement data. The method includes determining a Quality of Service (QoS) requirement for each segment. The method further includes determining for each segment whether the determined QoS requirement fulfills an estimated QoS maintained by the network node. When it has been determined that the QoS requirement for each segment fulfills the estimated QoS, the method further includes transmitting the at least one movement path to the one or more industrial devices.

### TECHNICAL FIELD

The present disclosure relates generally to movement of industrial devices in an industrial environment. More particularly, it relates to methods, network node, and computer program products for optimizing a planned movement of industrial devices in the industrial environment.

### BACKGROUND

Industrial automation is becoming increasingly popular due to rapid development in sensors, control system, and other manufacturing techniques. In industrial automation, various kinds of industrial devices (such as 6DOF robotic arms, collaborating robotic arms, Automated Guided Vehicles, AGVs, with omni-wheels, or other robotic devices) are used to automate various process in industries. For example, the industrial environment includes one or more industrial devices that receive a movement path from an industrial controller and the one or more industrial devices follow the received movement path accordingly.

The current industrial applications use wired connection between the industrial devices and the industrial controller. In wired networks, high-quality connectivity is available. Therefore, wired connection can always provide very low propagation delay and no packet loss.

Increased popularity of industrial automation leads to focus on developments where wireless connections are used between the industrial devices and the industrial controller. The wireless connection generally introduce more propagation delay and packet loss. For example, the wireless connections introduce additional non-ideality as compared to the wired connection. This non-ideality, e.g. increased jitter in command messages, can cause higher deviation from the desired movement path of the industrial devices and hence it reduces the accuracy of the trajectory execution of the industrial devices. A partial loss of packets or delayed reception of packets at the industrial devices can result in performance degradation or deviation from the desired movement path. The use of the appropriate radio connection for industrial applications is crucial for radio resource usage efficiency and industrial task execution accuracy.

### SUMMARY

Consequently, there is a need for an improved method and arrangement for optimization of the planned movement of the industrial devices that alleviates at least some of the above cited problems.

It is therefore an object of the present disclosure to provide a method, a network node and a computer program product for optimization of the planned movement of one or more industrial devices to mitigate, alleviate, or eliminate all or at least some of the above-discussed drawbacks of presently known solutions.

This and other objects are achieved by means of a method, a network node, and a computer program product as defined in the appended claims. The term exemplary is in the present context to be understood as serving as an instance, example or illustration.

According to a first aspect of the present disclosure, a method for optimizing the planned movement of one or more industrial devices is disclosed. The method is performed by the network node in the wireless communication network. The method comprises acquiring at least one movement path for the one or more industrial devices. Each movement path comprises one or more segments indicative of movement data. The method comprises determining a Quality of Service, QoS requirement for each segment. The method further comprises determining for each segment whether the determined QoS requirement fulfills an estimated QoS maintained by the network node. The method further comprises when it has been determined that the QoS requirement for each segment fulfills the estimated QoS, transmitting the at least one movement path to the one or more industrial devices.

In some embodiments, when it has been determined that the QoS requirement for at least one of the segment does not fulfill the estimated QoS, the method further comprising transmitting a message to an industrial application for regenerating the movement path. The message comprises one or more of at least one of the segments, position information about the at least one of the segment for which the determined QoS not fulfilling the estimated QoS, and maximum estimated QoS supported by the network node.

In some embodiments, the step of determining the QoS requirement for each segment comprises obtaining the one or more segments of the movement path, obtaining one or more segment types comprising at least one pre-determined parameter indicative of a state of movement of each industrial device along the movement path and identifying a segment type corresponding to each segment by analyzing each segment of the movement path. The method further comprises assigning the at least one pre-determined parameter to each segment based on the segment type of each segment, mapping the at least one pre-determined parameter of each segment with pre-determined QoS parameters of the network node and determining the QoS requirement for each segment based on the mapping.

In some embodiments, the state of movement of each industrial device comprises one or more of steady-state, accelerating state, decelerating state, travelling state, curving state, slaloming state, approaching state, and synchronized movement.

In some embodiments, wherein the at least one parameter comprises one or more of a movement-phase label indicating a current state of each industrial device along the movement path and an intensity value indicating a velocity of each industrial device along the movement path.

In some embodiments, the step of mapping the at least one pre-determined parameter of each segment with the pre-determined QoS parameters of the network node comprises obtaining a pre-determined QoS requirement information comprising a QoS requirement for each pre-determined QoS parameter. The method further comprises comparing the at least one parameter with the pre-determined QoS requirement.

In some embodiments, the step of determining for each segment whether the determined QoS requirement fulfills an estimated QoS maintained by the network node comprises acquiring a network coverage map indicating network conditions within the industrial environment. The method comprises obtaining the estimated QoS from the network coverage map and acquiring position information of the one or more industrial devices. The method further comprising comparing the QoS requirement for each segment and the position information with the estimated QoS. The method further comprises determining whether the network node is able to maintain the QoS requirement for each segment by comparing the QoS requirement with the estimated QoS.

In some embodiment, the method further comprises upon the determination that the wireless communication network is able to maintain the QoS requirement of the movement path, configuring at least one QoS parameter to maintain the QoS requirement for each segment.

In some embodiment, each segment of the movement path comprises movement data related to one or more of a velocity, a position information related to at least one joint of each industrial device, and an acceleration value.

According to a second aspect of the present disclosure, an apparatus of a network node configured to operate in a wireless communication network for optimizing a planned movement of one or more industrial devices in an industrial environment is provided. The apparatus comprising controlling circuitry configured to cause acquisition of at least one movement path for the one or more industrial devices. Each movement path comprises one or more segments indicative of movement data. The controlling circuitry is configured to cause determination of a Quality of Service, QoS requirement for each segment. Further, the controlling circuitry is configured to cause determination for each segment whether the determined QoS requirement fulfills an estimated QoS maintained by the network node. When it has been determined that the QoS requirement for each segment fulfills the estimated QoS, the controlling circuitry is configured to cause transmission of the at least one movement path to the one or more industrial devices.

A third aspect is a network node comprising the apparatus of the second aspect.

According to a fourth aspect of the present disclosure, there is provided a computer program product comprising a non-transitory computer readable medium, having thereon a computer program comprising program instructions. The computer program is loadable into a data processing unit and configured to cause execution of the method according to the first aspect when the computer program is run by the data processing unit.

In some embodiments, any of the above aspects may additionally have features identical with or corresponding to any of the various features as explained above for any of the other aspects.

An advantage of some embodiments is that alternative and/or improved approaches are provided for optimizing the planned movement of the industrial devices using the radio network conditions available in the industrial environment.

An advantage of some embodiments is that the increased the efficiency of radio resource usage is achieved in the industrial environment.

An advantage of some embodiments is that improved performance of the industrial application is achieved when the movement path is transmitted over wireless communication network.

An advantage of some embodiments is that there is no need to modify industrial application for transmission of the movement path to the industrial devices.

An advantage of some embodiments is that the performance degradation or failed operations in the industrial environment can be mitigated.

An advantage of some embodiments is that the desired movement path can be followed by the industrial devices with precision.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIG. 1 discloses an example of an industrial environment according to some embodiments;

FIG. 2 is a flowchart illustrating example method steps according to some embodiments;

FIG. 3 is a flowchart illustrating example method steps according to some embodiments;

FIG. 4 is a schematic block diagram illustrating an example apparatus according to some embodiments; and

FIG. 5 discloses an example computing environment according to some embodiments.

### DETAILED DESCRIPTION

Aspects of the present disclosure will be described more fully hereinafter with reference to the accompanying drawings. The apparatus and methods disclosed herein can, however, be realized in many different forms and should not be construed as being limited to the aspects set forth herein. Like numbers in the drawings refer to like elements throughout.

The terminology used herein is for the purpose of describing particular aspects of the disclosure only and is not intended to limit the invention. It should be emphasized that the term “comprises/comprising” when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Embodiments of the present disclosure will be described and exemplified more fully hereinafter with reference to the accompanying drawings. The solutions disclosed herein can, however, be realized in many different forms and should not be construed as being limited to the embodiments set forth herein.

It will be appreciated that when the present disclosure is described in terms of a method, it may also be embodied in one or more processors and one or more memories coupled to the one or more processors, wherein the one or more memories store one or more programs that perform the steps, services and functions disclosed herein when executed by the one or more processors.

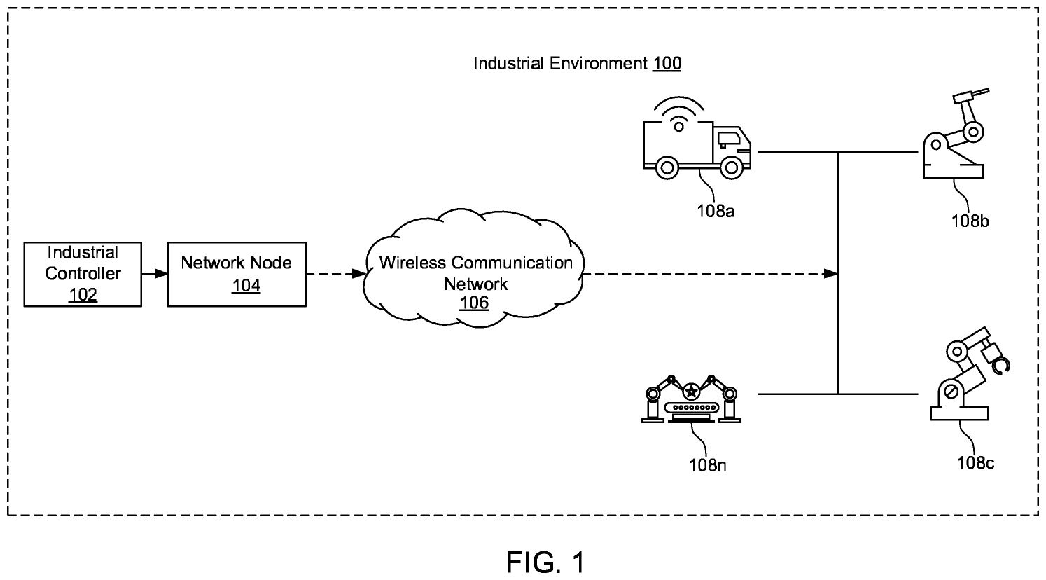

FIG. 1 discloses an industrial environment 100. Some of the examples of the industry environment 100 may include a factory, a manufacturing unit, guided robotic environment, etc. The industrial environment 100 comprises an industrial controller 102, a network node 104 and industrial devices 108a, 108b, 108c and so on to 108n. The network node 102 communicates with one or more industrial devices 108a-108n through a wireless communication network 106 for controlling the movement of one or more industrial devices 108a-108n. For example, the one or more industrial devices 108a-108n is configured to receive command messages and/or data packets from the network node 104 through the wireless communication network 106. For example, the network node 104 may be a radio access network comprising a plurality of base stations or evolved node base stations (not shown) or the internet using one or more suitable communication protocols for transmitting the data packets to the one or more industrial devices 108a-108n. The industrial controller 102 is configured to generate a movement path. Examples of the industrial devices 108a-108n may comprise Articulated Robots, Cartesian Robots, Selective Compliance Assembly Robot Arm, Delta robots, Polar robots, a 6-DOF robotic arm, collaborating robotic arms, Automated Guided Vehicles, AGVs, with omni-wheels, or other robotic devices.

The network node 104 is configured to acquire at least one movement path for industrial devices 108a-108n from the industrial controller 102. The movement path may be generated by an industrial application being executed in the industrial controller 102. Further, the network node 104 transmits the at least one movement path to the industrial devices 108a-108n through the wireless communication network 106. The industrial devices 108a-108n is configured to receive the at least one movement path from the network node 104. A trajectory may comprise the movement path to be followed by the industrial devices 108a-108n. For example, the industrial devices 108a-108n comprise one or more actuators (e.g. servos, arms, wheels, or the like) that move according to the movement path. In an ideal system, the execution of the movement path results in exact movement path. It should be noted that the industrial environment 100 is not limited to above-mentioned components, other components can also be present in the industrial environment 100 other than the component shown in the FIG. 1.

The wireless communication network 106 is used for transmission of the movement path to the industrial devices 108a-108n. The wireless connection generally introduces more propagation delay and packet loss. For example, the wireless connections introduce additional non-ideality as compared to the wired connection. This non-ideality, e.g. increased jitter in command messages, can cause higher deviation from the desired movement path of the industrial devices 108a-108n and hence it reduces the accuracy of the trajectory execution of the industrial devices 108a-108n. A partial loss of packets or delayed reception of packets at the industrial devices 108a-108n can result in performance degradation or deviation from the desired movement path. The use of the appropriate radio connection for industrial applications is crucial for radio resource usage efficiency and industrial task execution accuracy.

Therefore, according to some embodiments of the present disclosure, the network node 104 implements a method for optimizing a planned movement of one or more industrial devices 108a-108n, in the industrial environment 100.

According to some embodiments of the present disclosure, the network node 104 acquires at least one movement path for the one or more industrial devices 108a-108n. Each movement path comprises one or more segments indicative of movement data. For example, a trajectory includes one or more movement paths to be followed by the industrial devices 108a-108n.

Further, the network node 104 determines a Quality of Service, QoS requirement for each segment. The network node 104 determines for each segment whether the determined QoS requirement fulfills an estimated QoS maintained by the network node 104. For example, the network node 104 acquires a network coverage map maintained by the network node 104. The network coverage map indicates a network condition within a coverage area of the industrial environment 100. Further, the network node 104 obtains the estimated QoS using the network coverage map.

Further, when it has been determined that the QoS requirement for each segment fulfills the estimated QoS, the network node 104 transmits the movement path to the one or more industrial devices 108a-108n. For example, the network node 104 compares the QoS requirement for each segment and the position information with the estimated QoS and determines whether the network node 104 is able to maintain the QoS requirement for each segment. When it has been determined that the network node 104 is able to maintain the QoS requirement for each segment, the network node 104 configures at least one QoS parameter between the network node 104 and the one or more industrial devices 108a-108n. When it has been determined that the network node 104 is not able to maintain the QoS requirement for each segment, the network node 104 transmits a message to an industrial application for regenerating the movement path.

The network node 104 transmits the at least one movement path to the one or more industrial devices 108a-108n when it has been determined that the QoS requirement for each segment fulfills the estimated QoS. Further, the network node 104 discards the at least one movement path and transmits a message to the industrial device for regeneration of the movement path when it has been determined that the QoS requirement for each segment does not fulfill the estimated QoS. Thus, the performance degradation or deviation from the desired path of the industrial devices 108a-108n may be mitigated. Thereby, the embodiments herein provides optimization of the planned movement of the industrial devices 108a-108n in the industrial environment 100.

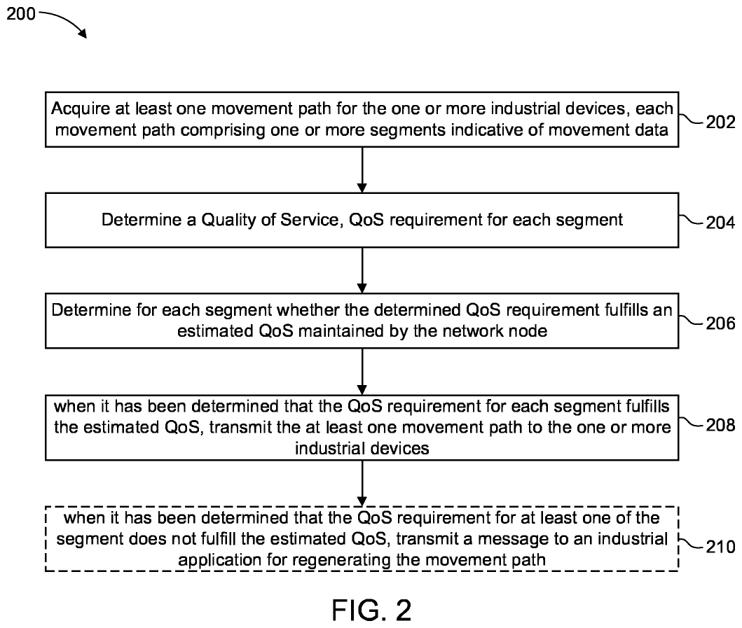

FIG. 2 is a flowchart illustrating example method steps of a method 200 performed by the network node in the wireless communication network for optimizing a planned movement of one or more industrial devices in the industrial environment.

At step 202, the method 200 comprises acquiring at least one movement path for the one or more industrial devices, each movement path comprising one or more segments indicative of movement data. The network node receives the at least one movement path from the industrial controller. For example, a trajectory includes one or more movement paths to be followed by the industrial devices for performing an assigned task or a sub-task of the assigned task. The trajectory of an industrial device typically includes the desired velocity information for each servo. For example, the trajectory for a 6 DOF robotic arm which has six servos can be defined as:

Trajectory =
Servo-1: {t=0 [sec], v=0 [rad/sec]}, {t=0.01 [sec], v=0.03 [rad/sec]},...,
{t=19.99 [sec], v=0.02 [rad/sec]}, {t=20 [sec], v=0.0 [rad/sec]}};
Servo-2: {t=0 [sec], v=0 [rad/sec]}, {t=0.01 [sec], v=0.02 [rad/sec]},...,
{t=19.99 [sec], v=0.04 [rad/sec]}, {t=20 [sec], v=0.0 [rad/sec]}}
...,
Servo-6: {t=0 [sec], v=0 [rad/sec]}, {t=0.01 [sec], v=0.01 [rad/sec]},...,
{t=19.99 [sec], v=0.04 [rad/sec]}, {t=20 [sec], v=0.0 [rad/sec]}}]

The trajectory instructs the industrial device on how to move for an assigned time interval. The industrial device composed of one or more actuators (e.g. servos, wheels, arms, or the like) for performing the assigned task. The movement path includes a desired velocity function for each actuator of the industrial device. Additionally, the movement path comprises joint positions and acceleration values. The movement path can be specified by splines. The movement path may be segmented into one or more segments. Each segment comprises movement data which includes a value for a desired velocity at a given time interval. For example, if the trajectory comprises the movement path for 20 seconds, the movement path may be divided into 100 small segments. Thus, each segment describes a desired velocity for a time interval of 0.2 seconds.

At step 204, the method 200 comprises determining the QoS requirement for each segment. The network node analyses each segment of the movement path. Based on the analysis, the network node determines the QoS requirement for each segment. The QoS requirement indicates the quality of coverage of the wireless network within the industrial environment based on the position and/or movement of the industrial devices within the industrial environment.

Examples of the QoS requirement may include Static-QoS and Dynamic QoS. In the Static-QoS, the whole movement path has a single QoS requirement. The strictest QoS requirement considered and that should be available along the complete movement path. In the Dynamic QoS, each segment of the movement path has its own QoS requirement and radio connection is reconfigured dynamically.

In some embodiments, the industrial controller recalculates the movement path to avoid challenging radio zones or decreases the speed of the movement of the industrial devices. The network node identifies the weak points of radio coverage and provides them to the industrial controller for re-planning of the movement path.

In other embodiments. The network node obtains the one or more segments of the movement path. For example, the network node may segment the movement path into one or more segments. Further, the network node obtains one or more segment types comprising at least one pre-determined parameter indicative of a state of movement of each industrial device along the movement path. The examples of the state of movement of the industrial device may include Steady-state, Accelerating state, Decelerating state, Travelling state, Curving state, Slaloming state, Approaching state, Synchronized movement or the like. The examples of the at least one parameter comprises one or more of a movement-phase label indicating a current state of each industrial device along the movement path, an intensity value indicating a velocity of each industrial device along the movement path or the like.

The network node identifies a segment type corresponding to each segment by analyzing each segment of the movement path. For example, the network node extracts each segment of the movement path and determines a state of the industrial device. Further, the network node compares the state of the industrial device with the at least one pre-determined parameter to identify the segment type. The network node assigns the at least one pre-determined parameter of each segment based on the segment type of each segment. The network node further contracts the adjacent segments with same label. Further, the network node contracts the adjacent segments (e.g. Curving/Accelerating/Decelerating/Travelling segments) to a single segment (e.g. a Slaloming segment).

The network node assigns an intensity value to each segment of the movement path. The movement-phase label indicates a state of movement of each industrial device along the movement path. The network node determines the intensity value based on the state of each industrial device. For example, the intensity parameter for steady state is determined as zero. The network node assigns the movement-phase label and the intensity value by using a pre-determined table as shown in table 1.

TABLE 1

| Movement-phase label | Detection | Intensity values |
|---|---|---|
| Steady-state | Every servo is stopped | — |
| Accelerating state | Velocity of each servo is | max(acceleration-i) |
| | increasing linearly in joint | |
| | space | |
| Decelerating state | Velocity of each servo is | max(deceleration-i) |
| | decreasing linearly in joint | |
| | space | |
| Travelling state | Each servo has constant | max(velocity-i) |
| | velocity | |
| Curving state | Some servos are changing | max[max (velocity-i(t))- |
| | its velocity, but no change in | min(velocity-i(t))] |
| | direction of velocity change. | |
| | The sign of the acceleration | |
| | is not changed. | |
| Slaloming state | Servo's velocities are | max[max (velocity-i(t))- |
| | varying. The sign of the | min(velocity-i(t))] |
| | acceleration is also changed | |
| | for some servos. | |
| Approaching state | Tail part of the trajectory | max(deceleration-i) |
| | when the goal position is | |
| | approaching. Trajectory | |
| | contains a refinement | |
| | period, where velocity | |
| | values already zeros. | |
| Synchronized movement | There are another trajectory | — |
| | near to this trajectory in | |
| | world-frame or there are | |
| | trajectory moving parallel | |
| | this trajectory (cooperating | |
| | trajectories) | |

The network node further maps the at least one pre-determined parameter of each segment with pre-determined QoS parameters of the network node. For example, the network node obtains the pre-determined QoS parameters of the network node and compares the obtained pre-determined QoS parameters with the assigned movement-phase label and the intensity parameter of each segment of the movement data. The mapping functionality can be rule-based method, supervised learning method (if labeled training data is available, e.g., from simulation or measurement) or simply determined by using expert knowledge. Further, the network node determines the QoS requirement for each segment based on the mapping. For example, the network node extracts a configured QoS requirements from the pre-determined QoS parameters based on the assigned movement-phase label and the intensity parameter of each segment.

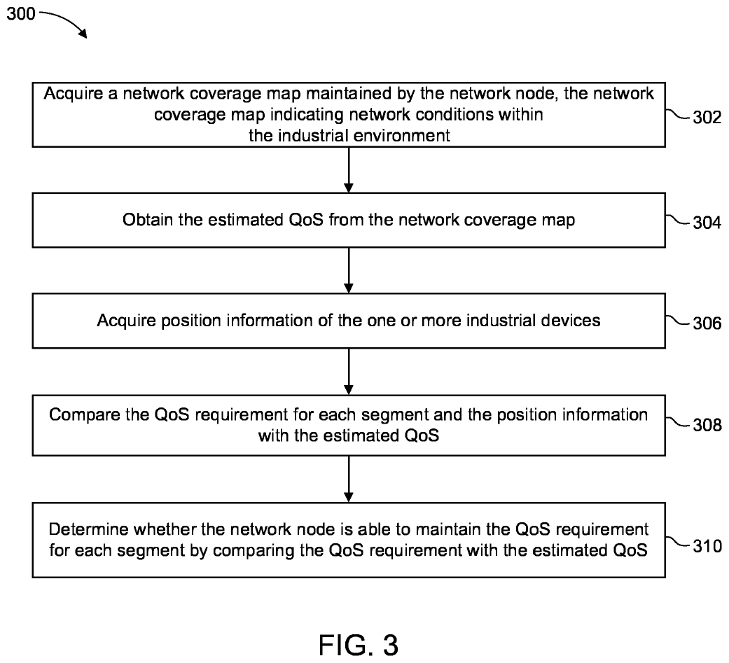

At step 206, the method 200 comprises determining for each segment whether the determined QoS requirement fulfills an estimated QoS maintained by the network node. The network node determines the estimated QoS using a network coverage map maintained by the network node. Further, the network node determines whether the QoS requirement for each segment fulfills the estimated QoS maintained by the network node. The step of determining for each segment whether the determined QoS requirement fulfills an estimated QoS maintained by the wireless communication network is explained in conjunction with FIG. 3.

At step 208, the method 200 comprises transmitting the at least one movement path to the one or more industrial devices when it has been determined that the QoS requirement for each segment fulfills the estimated QoS. The network node configures at least one QoS parameter to maintain the QoS requirement for each segment when it has been determined that the QoS requirement for each segment fulfills the estimated QoS. For example, the network node updates the QoS parameters of radio resources such that the QoS requirement of each segment fulfils the estimated QoS.

Furthermore, when it has been determined that the QoS requirement for at least one of the segments does not fulfill the estimated QoS, the network node transmits a message to an industrial application for regenerating the movement path as depicted in optional step 210. The message comprises one or more of the at least one of the segments, position information about the at least one of the segments, and maximum estimated QoS supported by the network node. For example, the network node determines the segments for which the QoS requirement does not fulfills the estimated QoS and extracts the maximum estimated QoS supported by the network node. Further, the network node generates the message comprising one or more of the at least one of the segments, position information about the at least one of the segments, and maximum estimated QoS supported by the network node.

Thus, the network node considers the available radio network condition within the industrial environment before transmitting the movement path to the industrial devices. Thus, the performance degradation or deviation from the desired path of the industrial devices may be mitigated. Thereby, the embodiments herein provides optimization of the planned movement of the industrial devices 108a-108n in the industrial environment 100.

FIG. 3 is a flowchart illustrating example method steps of a method 300 performed by the network node in the wireless communication network for determining for each segment whether the determined QoS requirement fulfills an estimated QoS maintained by the wireless communication network.

At step 302, the method 300 comprises acquiring a network coverage map maintained by the network node. The network coverage map indicates network conditions within the industrial environment. For example, the network node acquires the network coverage map indicating a network condition within a coverage area of the industrial environment. The network coverage map comprises details of the signal condition at each location within the coverage area of the industrial environment. The signal condition varies within the coverage area depending upon the location of the industrial devices.

At step 304, the method comprises obtaining the estimated QoS from the network coverage map. The network node analyses the network coverage map and obtains the estimated QoS maintained by the network node. For example, the network node estimates the service quality of the network node of the coverage area of the industrial environment. Further, the network node obtains the estimated QoS according to the service quality of the network node within the coverage area.

At step 306, the method 300 comprises acquiring position information of the one or more industrial devices. The network node acquires the position information of each industrial device. The position information indicates a starting point and a target point of movement path. The position information of the starting point and the target point is described by co-ordinates of the locations. The movement path further includes one or more routes between the starting point and the target point.

At step 308, the method 300 comprises comparing the QoS requirement for each segment and the position information with the estimated QoS. The network node considers the QoS requirement for each segment along with the position information and compares with the estimated QoS. For example, the network node determines the radio network conditions by using the network coverage map and compares the radio network conditions with the QoS requirement for each segment and the position information.

At step 310, the method 300 comprises determining whether the network node is able to maintain the QoS requirement each segment by comparing the QoS requirement with the estimated QoS. The network node evaluates the QoS requirement and determines whether the network node is able to maintain the QoS requirement for each segment of the movement path. The network node determines whether the requested QoS can be guaranteed for the movement path by comparing the QoS requirement for each segment with the position information with the estimated QoS. For example, the network node checks a spatial and a temporal availability of desired connectivity by using the QoS requirement extended with the position information. The spatial and temporal availability indicates whether the QoS requirement can be fulfilled by the available radio resources of the network node. The QoS requirement extended with the position information may provide relatively more accuracy.

Upon the determination that the network node is able to maintain the QoS requirement for each segment, the network node configures at least one QoS parameter to maintain the QoS requirement for each segment. Further, upon the determination that the network node is not able to maintain the QoS requirement for at least one of the segments, the network node transmits a message to an industrial application for regenerating the movement path. For example, the network node generates the message that instructs the industrial application to redesign the movement path for controlling the movement of the industrial devices. The message comprises information required for redesigning the movement path. The information required for redesigning the movement path may comprise at least one segment for which the network node is not able to maintain the QoS requirement, the position of the at least one segment and the maximum estimated QoS supported by the network node. The industrial application receives the message and regenerates the movement path according to the message. The industrial application may consider the information in the message in regeneration of the movement path such that the regenerated movement path can be transmitted to the industrial devices in accordance with the QoS requirement. As an example, acceleration, deceleration and nonlinear motion segments require high QoS in radio connection. If that is not available, for instance, due to bad radio coverage, then the industrial application receives a feedback and regenerates the movement path such as decreasing the speed of the movement of the industrial devices, avoiding the segments that requires the industrial devices to move into challenging radio zones, avoiding acceleration, deceleration and nonlinear travelling motion segments when travelling through challenging radio zones. Thus, the network node is able to maintain the QoS requirement of the movement path. The method can be used in an iterative design method where the movement path and the radio network are jointly optimized.

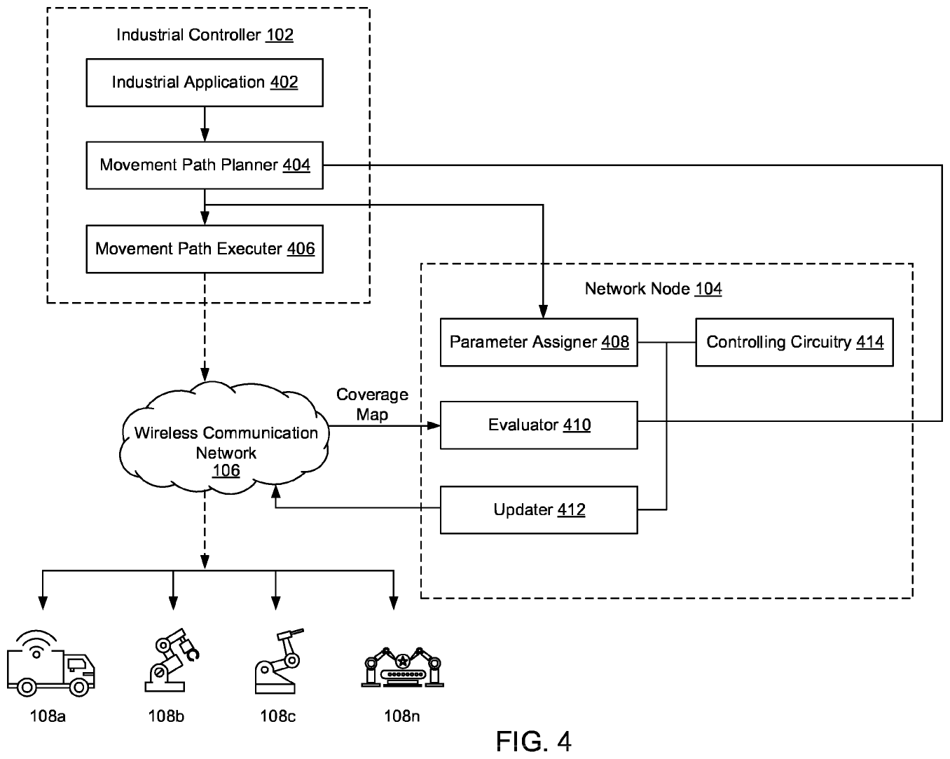

FIG. 4 is an example schematic diagram showing apparatuses 102 and 104. The apparatus 102 may e.g. be comprised in the industrial controller. The apparatus 104 may e.g. be comprised in a network node. The apparatus 102 is capable of generating the movement plan on the basis of the input received from the user. The apparatus 104 is configured to cause performance of the method 200 for optimizing a planned movement of one or more industrial devices, in an industrial environment.

According to at least some embodiments of the present invention, the apparatus 102 in FIG. 4 comprises one or more modules. These modules may e.g. be an industrial application 402, a movement path planner 404, and a movement path executer 406.

As described above, the various ways of transmitting the data packets to UE to deliver the control message to each of the plurality of industrial devices, a few of which have been mentioned above in connection to the explanation of FIG. 2.

The industrial application 402 is configured to execute an application for controlling the industrial devices 108a-108n. The application may be any kind of application that generates commands to be followed by the industrial devices 108a-108n. The industrial application 402 further control the movement path planner 404 to generate at least one movement path for controlling the movement of the industrial devices 108a-108n.

The movement path planner 404 is configured to obtain input from the industrial devices 108a-108n and generate the at least one movement plan based on the received input. The movement planner 404 is further capable of regenerating the movement plan based on the message received from the network node 104. For example, the movement planner 404 receive the message from the network node 104 when it is determined that the network node is not able to maintain the QoS requirement.

The movement path executer 406 receives that movement path from the movement path planner 404. Further, the movement path executer 406 executes the movement plan for each industrial device 108a-108n. For example, the movement path executer 406 extracts the movement plan for each industrial device 108a-108n and implements the movement path to each industrial device 108a-108n.

According to at least some embodiments of the present invention, the apparatus 104 in FIG. 4 comprises one or more modules. These modules may e.g. be parameter assigner 408, an evaluator 410, an updater 412, and a controlling circuitry 414.

The parameter assigner 408 is configured to receive the movement path from the movement path planner 404. The parameter assigner 408 further assigns the at least one parameter to each segment of the movement plan. The at least one parameter is assigned to each segment according to table 1.

The evaluator 410 obtains the assigned segments from the parameter assigner 408. Further, the evaluator 410 acquires the network coverage map maintained by the network node. The evaluator 410 evaluates the QoS requirement for each segment with regard to fulfilling a desired QoS, determined using the network coverage map maintained by the network node. For example, the evaluator 410 determines whether the network node 104 is able to maintain the QoS requirement for the movement path by comparing the QoS requirement with the network coverage map. Further, the evaluator is configured to transmit the message to the industrial controller 102 when it is determined that that the wireless communication network is not able to maintain the QoS requirement of the movement path.

The updater 412 is configured to configure at least one QoS parameter to maintain the QoS requirement for each segment when it is determined that the network node is able to maintain the QoS requirement of the movement path.

The controlling circuitry 414 may be adapted to control the steps as executed by the network node 104. For example, the controlling circuitry 414 may be adapted to control the one or more modules comprised in network node 104 (as described above in conjunction with the method 200 and FIG. 2).

Further, the network node 104 is configured to transmit the movement path to the industrial devices 108a-108n in accordance with the QoS requirement for each segment. Thus, the performance degradation or deviation from the desired path of the industrial devices 108a-108n may be mitigated. Thereby, the embodiments herein provides optimization of the planned movement of the industrial devices 108a-108n in the industrial environment 100.

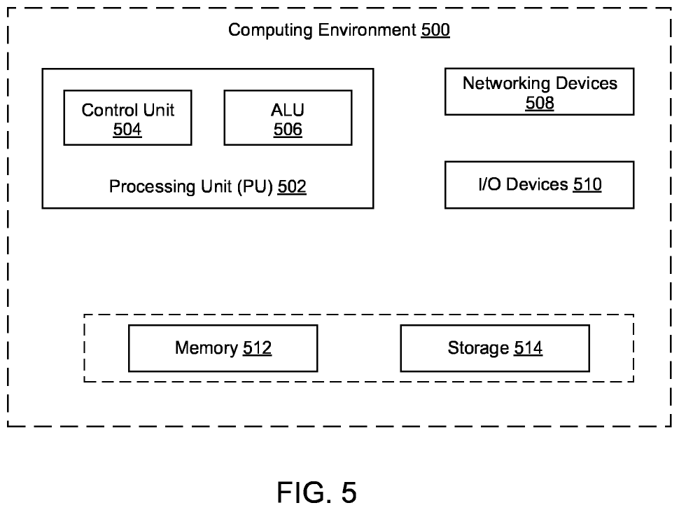

FIG. 5 illustrates an example computing environment 500 implementing a method and the network node and the UE as described in FIGS. 2 and 3. As depicted in FIG. 5, the computing environment 500 comprises at least one processing unit 502 that is equipped with a control unit 504 and an Arithmetic Logic Unit (ALU) 506, a plurality of networking devices 508 and a plurality Input output, I/O devices 510, a memory 512, and a storage 514. The processing unit 502 may be responsible for implementing the method described in FIGS. 2-3. For example, the processing unit 502 may in some embodiments be equivalent to the processor of the network node and the UE described above in conjunction with the FIGS. 1-4. The processing unit 502 is capable of executing software instructions stored in memory 512. The processing unit 502 receives commands from the control unit 504 in order to perform its processing. Further, any logical and arithmetic operations involved in the execution of the instructions are computed with the help of the ALU 506.

The computer program is loadable into the processing unit 502, which may, for example, be comprised in an electronic apparatus (such as a UE or a network node). When loaded into the processing unit 502, the computer program may be stored in the memory 512 associated with or comprised in the processing unit 502. According to some embodiments, the computer program may, when loaded into and run by the processing unit 502, cause execution of method steps according to, for example, any of the methods illustrated in FIGS. 2 and 3 or otherwise described herein.

The overall computing environment 500 may be composed of multiple homogeneous and/or heterogeneous cores, multiple CPUs of different kinds, special media and other accelerators. Further, the plurality of processing unit 502 may be located on a single chip or over multiple chips.

The algorithm comprising of instructions and codes required for the implementation are stored in either the memory 512 or the storage 514 or both. At the time of execution, the instructions may be fetched from the corresponding memory 512 and/or storage 514, and executed by the processing unit 502.

In case of any hardware implementations various networking devices 508 or external I/O devices 510 may be connected to the computing environment to support the implementation through the networking devices 508 and the I/O devices 510.

The embodiments disclosed herein can be implemented through at least one software program running on at least one hardware device and performing network management functions to control the elements. The elements shown in FIG. 5 include blocks which can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the disclosure.

1. A method for optimizing a planned movement of one or more industrial devices, in an industrial environment, the method being performed by a network node, in a wireless communication network, the method comprising:
acquiring at least one movement path for the one or more industrial devices, each movement path comprising one or more segments indicative of movement data;
determining a Quality of Service (QoS) requirement for each segment;
determining for each segment whether the determined QoS requirement fulfills an estimated QoS maintained by the network node; and
when it has been determined that the QoS requirement for each segment fulfills the estimated QoS, transmitting the at least one movement path to the one or more industrial devices.

2. The method according to claim 1, further comprising:
when it has been determined that the QoS requirement for at least one of the segment does not fulfill the estimated QoS, transmitting a message to an industrial application for regenerating the movement path.

3. The method according to claim 2, wherein the message comprises one or more of:
at least one of the segment for which the determined QoS not fulfilling the estimated QoS;
position information about the at least one of the segment; and
maximum estimated QoS supported by the network node.

4. The method according to claim 1, wherein the step of determining the QoS requirement for each segment comprises:
obtaining the one or more segments of the movement path;
obtaining one or more segment types comprising at least one pre-determined parameter indicative of a state of movement of each industrial device along the movement path;
identifying a segment type corresponding to each segment by analyzing each segment of the movement path;
assigning the at least one pre-determined parameter to each segment based on the segment type of each segment;
mapping the at least one pre-determined parameter of each segment with pre-determined QoS parameters of the network node; and
determining the QoS requirement for each segment based on the mapping.

5. The method according to claim 4, wherein the state of movement of each industrial device comprises one or more of steady-state, accelerating state, decelerating state, travelling state, curving state, slaloming state, approaching state, and synchronized movement.

6. The method according to claim 4, wherein the at least one parameter comprises one or more of:
a movement-phase label indicating a current state of each industrial device along the movement path; and
an intensity value indicating a velocity of each industrial device along the movement path.

7. The method according to claim 4, wherein the step of mapping the at least one pre-determined parameter of each segment with the pre-determined QoS parameters of the network node comprises:
obtaining a pre-determined QoS requirement information comprising a QoS requirement for each pre-determined QoS parameter; and
comparing the at least one parameter with the pre-determined QoS requirement.

8. The method according to claim 1, wherein the step of determining for each segment whether the determined QoS requirement fulfills an estimated QoS maintained by the network node comprises:
acquiring a network coverage map indicating network conditions within the industrial environment;
obtaining the estimated QoS from the network coverage map;
acquiring position information of the one or more industrial devices;
comparing the QoS requirement for each segment and the position information with the estimated QoS; and
determining whether the network node is able to maintain the QoS requirement for each segment by comparing the QoS requirement with the estimated QoS.

9. The method according to claim 8, further comprising:
upon the determination that the network node is able to maintain the QoS requirement for each segment, configuring at least one QoS parameter to maintain the QoS requirement for each segment.

10. The method according to claim 1, wherein each segment of the movement path comprises movement data related to one or more of a velocity, a position information related to at least one joint of each industrial device and an acceleration value.

11. An apparatus of a network node configured to operate in a wireless communication network for optimizing a planned movement of one or more industrial devices in an industrial environment, the apparatus comprising controlling circuitry configured to cause:
acquisition of at least one movement path for the one or more industrial devices, each movement path comprising one or more segments indicative of movement data;
determination of a Quality of Service (QoS) requirement for each segment;
determination for each segment whether the determined QoS requirement fulfills an estimated QoS maintained by the network node; and
when it has been determined that the QoS requirement for each segment fulfills the estimated QoS, transmission of the at least one movement path to the one or more industrial devices.

12. The apparatus according to claim 11, wherein the controlling circuitry is further configured to cause:
when it has been determined that the QoS requirement for at least one of the segment does not fulfill the estimated QoS, transmission of a message to an industrial application for regenerating the movement path.

13. The apparatus according to claim 12, wherein the message comprises one or more of:
at least one of the segment for which the determined QoS not fulfilling the estimated QoS;
position information about the at least one of the segment; and
maximum estimated QoS supported by the network node.

14. The apparatus according to claim 11, wherein the controlling circuitry is configured to cause the step of determining the QoS requirement for each segment by causing:
obtaining of the one or more segments of the movement path;
obtaining of one or more segment types comprising at least one pre-determined parameter indicative of a state of movement of each industrial device along the movement path;
identification of a segment type corresponding to each segment by analyzing each segment of the movement path;
assignment of the at least one pre-determined parameter to each segment based on the segment type of each segment;
mapping of the at least one pre-determined parameter of each segment with pre-determined QoS parameters of the network node; and
determination of the QoS requirement for each segment based on the mapping.

15. The apparatus according to claim 14, wherein the state of movement of each industrial device comprises one or more of steady-state, accelerating state, decelerating state, travelling state, curving state, slaloming state, approaching state, and synchronized movement.

16. The apparatus according to claim 14, wherein the at least one parameter comprises one or more of:
a movement-phase label indicating a current state of each industrial device along the movement path; and
an intensity value indicating a velocity of each industrial device along the movement path.

17. The apparatus according to claim 14, wherein the controlling circuitry is configured to cause the step of mapping the at least one pre-determined parameter of each segment with the pre-determined QoS parameters of the network node by causing:
obtaining of a pre-determined QoS requirement information comprising a QoS requirement for each pre-determined QoS parameter; and
comparison of the at least one parameter with the pre-determined QoS requirement.

18. The apparatus according to claim 11, wherein the controlling circuitry is configured to cause the step of determining for each segment whether the determined QoS requirement fulfills an estimated QoS maintained by the network node by causing:
acquisition of a network coverage map indicating network conditions within the industrial environment;
obtaining of the estimated QoS from the network coverage map;
acquisition of position information of the one or more industrial devices;
comparison of the QoS requirement for each segment and the position information with the estimated QoS; and
determination of whether the network node is able to maintain the QoS requirement for each segment by comparing the QoS requirement with the estimated QoS.

19. The apparatus according to claim 18, wherein the controlling circuitry is further configured to cause:
upon the determination that the network node is able to maintain the QoS requirement for each segment, configuration of at least one QoS parameter to maintain the QoS requirement for each segment.

20-21. (canceled)

22. A computer program product comprising a non-transitory computer readable medium, having thereon a computer program comprising program instructions, the computer program is loadable into a data processing unit and configured to cause execution of the method according to claim 1 when the computer program is run by the data processing unit.
